(19) United States
(12) Patent Application Publication
(10) Pub. No.: US 2008/0316246 A1
(43) Pub. Date: Dec. 25, 2008

(54) METHOD FOR CALIBRATING AN INK SENSE RESPONSE IN AN APPARATUS CONFIGURED TO FACILITATE OPTICAL INK SENSING

(76) Inventors: Jason Todd McReynolds, Georgetown, KY (US); Robert Muyskens, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/766,138

(22) Filed: Jun. 21, 2007

(51) Int. Cl. B41J 29/393; B41J 2/195

(52) U.S. Cl. 347/19; 347/7

(57) ABSTRACT

A method for calibrating as ink sense response of an optical ink sensor device in an imaging apparatus configured to facilitate optical ink sensing for an ink tank having an ink sensing window includes obtaining a calibration response to a reference reflective surface having a known reflectivity, which is associated with a printhead carrier of the imaging apparatus that carries the ink tank, using the optical ink sensor device; and calibrating the ink sense response based on the calibration response.

### BACKGROUND OF THE INVENTION

1. Field of the Invention

The present invention relates to ink jet printing, and, more particularly, to a method for calibrating an ink sense response in an apparatus configured to facilitate optical ink sensing.

2. Description of the Related Art

An imaging apparatus, such as an ink jet printer, forms an image on a print medium, such as paper, by applying ink to the print medium. The ink may be contained in one or more replaceable supply cartridges. Examples of such, replaceable supply cartridges include a replaceable ink tank and an ink jet printhead cartridge. An ink jet printhead cartridge, for example, includes both an ink tank and a printhead (e.g., an ink jet micro-fluid ejection device) in a unitary non-separable device. In contrast, a replaceable ink tank is indirectly coupled via a fluid interface to a separate printhead, and wherein the printhead is separately attached to the printhead carrier.

One such ink jet printer mounts a plurality of replaceable ink tanks, with each ink tank containing a supply of a particular color of ink, e.g., black, cyan, magenta, and yellow. The ability to perform the detection of ink in an ink tank as accurately as possible is desirable so as to avoid damage to the associated printhead and to maintain consumer satisfaction. For example, continuing to print without having ink in one or more of the ink tanks may cause ink starvation to the printhead and in turn a thermal overload on the printhead, likely resulting in severe damage to the printhead. On the opposite extreme, stopping printing too early to overly protect the printhead would tend to reduce page yields from a given ink tank, and may reduce consumer satisfaction.

### SUMMARY OF THE INVENTION

The invention, in one form thereof is directed to a method for calibrating an ink sense response of an optical ink sensor device in an imaging apparatus configured to facilitate optical ink sensing for an ink tank having an ink sensing window. The method includes obtaining a calibration response to a reference reflective surface having a known reflectivity, which is associated with a printhead carrier of the imaging apparatus that carries the ink tank, using the optical ink sensor device; and calibrating the ink sense response based on the calibration response.

The invention, in another form thereof, is directed to an imaging apparatus. The imaging apparatus includes a printhead carrier. A printhead is coupled to the printhead carrier. An ink tank is coupled to the printhead carrier. The ink tank has an ink sensing window. A memory is associated with the ink tank. An optical ink sensor device is positioned to receive light reflected from the ink sensing window for sensing an ink tank status to facilitate optical ink sensing for the ink tank. A reference reflective surface is carried by the printhead carrier. The reference reflective surface has a known reflectivity. A controller is communicatively coupled to the printhead, the memory, and the optical ink sensor device. The controller executes program instructions for calibrating an ink sense response of the optical ink sensor device in the imaging apparatus by obtaining a calibration response of the optical ink sensor device to the reference reflective surface, and calibrating the ink sense response based on the calibration response.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a perspective pictorial illustration of the printhead carrier of FIG. 1, showing the relative position of an optical ink sensor device with respect to the printhead carrier and the ink tanks mounted thereto.

FIG. 3 is a block diagram of an exemplary circuit for the optical ink sensor device of FIG. 2.

FIG. 4 shows a graph plotting the detection signal from the ADC circuit in the exemplary circuit for the optical ink sensor device of FIG. 3.

FIG. 5 is a flowchart of a general method for calibrating an ink sense response of the optical ink sensor device in the imaging apparatus of FIG. 1.

FIG. 6 is a flowchart of method acts according to one exemplary embodiment for performing the act of calibrating the ink sense response based on the calibration response in the general method of FIG. 5.

FIG. 7 is a flowchart of method acts according to another exemplary embodiment for performing the act of calibrating the ink sense response based on the calibration response in the general method of FIG. 5.

### DETAILED DESCRIPTION OF THE INVENTION

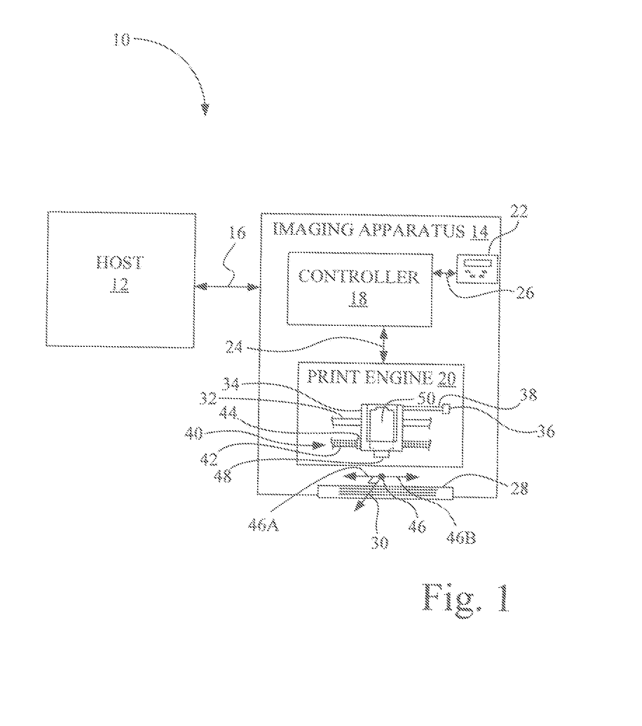

Referring to FIG. 1, there is shown a diagrammatic depiction of an imaging system 10 embodying the present invention. Imaging system 10 may include a host 12 and an imaging apparatus 14. Imaging apparatus 14 may communicate with host 12 over a communication link 16. As used herein, the term “communications link” is used to generally refer to structure that facilitates electronic communication between multiple components, and may operate using wired or wireless technology. Imaging, apparatus 14 may communicate with host 12 via a standard communication protocol, such as for example, universal serial bus (USB), Ethernet or IEEE 802.1x, etc.

As used herein, the term “imaging apparatus” is a device that forms a printed image on a print medium. In the embodiment shown in FIG. 1, imaging apparatus 14 is shown as printer that includes a controller 18, a print engine 20 and a user interface 22. Alternatively, imaging apparatus 14 may be a standalone unit that is not communicatively linked to a host, such as host 12. For example, imaging apparatus 14 may take the form of an all-in-one. i.e., multifunction, machine that includes a scanner to facilitate standalone copying and facsimile capabilities, in addition to optionally serving as a printer when attached to a host, such as host 12.

Host 12 may be, for example, a personal computer including an input/output (I/O) device, such as keyboard and display monitor. Host 12 further includes a processor, input/output (I/O) interfaces, memory, such as RAM, ROM, NVRAM, and a mass data storage device, such, as a hard drive, CD-ROM and/or DVD units. During operation, host 12 may include in its memory a software program including program instructions that function as an imaging driver, e.g., printer driver software, for imaging apparatus 14. Alternatively, the imaging driver may be incorporated, in whole or in part, in imaging apparatus 14.

Controller 18 of imaging apparatus 14 includes a processor unit and associated memory, and may be formed as an Application Specific Integrated Circuit (ASIC). Controller 18 communicates with print engine 20 by way of a communications link 24. Controller 18 communicates with user interface 22 by way of a communications link 26. Communications links 24 and 26 may be established, for example, by using standard electrical cabling or bus structures, or by wireless connection.

In the present embodiment, print engine 20 of imaging apparatus 14 is an ink jet print engine configured for forming an image on a sheet of print media 28, such as a sheet of paper, transparency or fabric that is transported in a sheet feed direction 30.

Print engine 20 may include, for example, a guide frame 32, a reciprocating printhead carrier 34, a drive motor 36, a drive belt 38, and a carrier position encoder 40. Carrier position encoder 40 includes a linear encoder strip 42 and an encoder sensor 44. Printhead carrier 34 is slidably coupled to guide frame 32. Drive belt 38 is connected to printhead carrier 34, and is driven by drive motor 36 operating under the control of controller 18.

Guide frame 32 defines a bi-directional main scan path 46, including direction 46A and direction 46B. During a printing operation, guide frame 32 guides printhead carrier 34 back and forth along bi-directional main scan path 46, with drive motor 36 and drive belt 38 providing the motive force to move printhead carrier 34. Encoder sensor 44 of carrier position encoder 40 is communicatively coupled to controller 18, and reads linear encoder strip 42 as printhead carrier 34 is moved so as to provide carrier position data to controller 18 corresponding to a relative linear position of printhead carrier 34 along bi-directional main scan path 46. Bi-directional main scan path 46 is perpendicular to sheet feed direction 30.

Printhead carrier 34 is mechanically and electrically configured to mount and carry at least one printhead 48. Each printhead 48 is in fluid communication with at least one ink tank 50. In one embodiment, for example, printhead 48 and ink tank 50 and may be formed as an integral printhead cartridge, so as to be replaceable as a non-separable unit. In another embodiment, printhead 48 and Ink tank 50 may be designed in be separable, so as to be individually replaceable, with printhead 48 being semi-permanently mounted to printhead carrier 34 (i.e., usable with multiple replaceable ink tanks 50), and with each ink tank 50 being replaceably coupled to printhead carrier 34 and printhead 48. In either embodiment, during a priming operation printhead carrier 34 transports printhead 48 in a reciprocating manner over an image surface of the sheet of print media 28. Based on print commands provided by controller 18, printhead 48 selective ejects Ink to form an image on the sheet of print media 28.

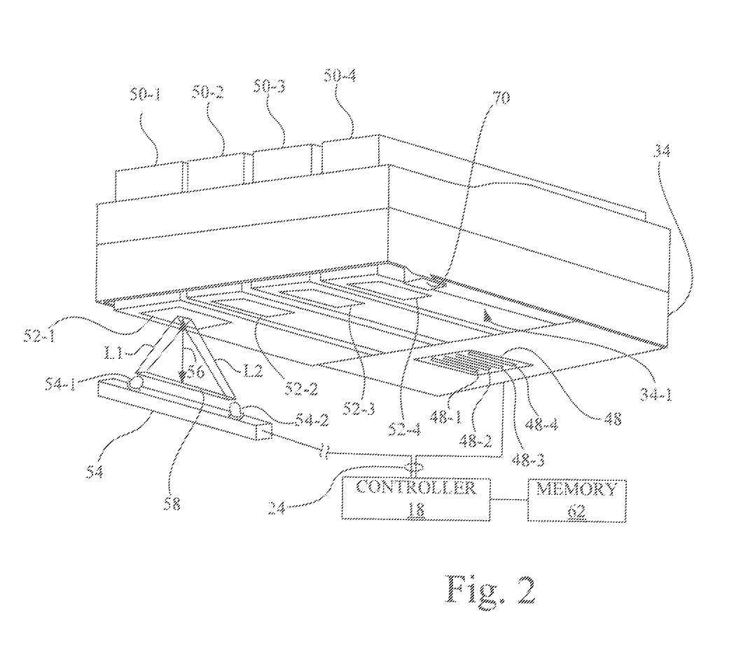

In the embodiment shown in FIG. 2, a plurality of removable ink tanks 50, individually identified as ink tanks 50-1, 50-2, 50-3 and 50-4, is mounted to printhead carrier 34, and are in fluid communication with printhead 48. Each of ink tanks 50-1, 50-2, 50-3 and 50-4 may include, for example, a specific ink type, such as one of a monochrome ink, a yellow ink, a magenta ink and a cyan ink. Printhead 48 may include a respective ink jet nozzle array 48-1, 48-2, 48-3, 48-4 for each color of ink. Each of ink tanks 50-1, 50-2, 50-3 and 50-4 includes a respective ink sensing window 52-1, 52-2, 52-53, and 52-4 formed on a bottom surface of the respective ink tank. Each ink sensing window is formed from a transparent material, such as a transparent plastic.

Print engine 20 includes an optical ink sensor device 54 having a light emitter 54-1 and a light detector 54-2 for detecting the presence of ink in each of ink tanks 50-1, 50-2, 50-3 and 50-4 by reflecting a portion of the emitted light L1 off of a respective ink sensing window 52-1, 52-2, 52-3, and 52-4. The amount of light L2 reflected off of a respective ink sensing window 52-1, 52-2, 52-3, and 52-4 is used to judge the presence of ink that is found in each respective ink tank 50-1, 50-2, 50-3 and 50-4. Optical ink sensor device 54 is positioned in print engine 20 at a location such that each of the ink sensing windows 52-4, 52-2, 52-3, and 52-4 of ink tanks 50-1, 50-2, 50-3 and 50-4 may be selectively positioned over optical ink sensor device 54 for taking a reading from each ink tank 50-1, 50-2, 50-3 and 50-4 by moving printhead carrier 34.

In general, each of the ink sensing windows 52-1, 52-2, 52-3, and 52-4 of ink tanks 50-1, 50-2, 50-3 and 50-4 is separated from the sensing components 54-1, 54-2 of optical ink sensor device 54 by a distance 56. For example, distance 56 may extend from the respective ink sensing window to a plane 58 extending between light emitter 54-1 and light detector 54-2. In the example shown in FIG. 2, printhead carrier 34 is positioned at a location along bi-directional main scan path 46 such that ink sensing window 52-1 is positioned to be centered over and perpendicular to plane 58 of optical ink sensor device 54 during the ink sensing for ink tank 50-1.

In practice, however, even when each of ink sensing windows 52-1, 52-2, 52-3, and 52-4 is positioned to be centered over and perpendicular to optical ink sensor device 54, the distance 56 may very from one ink tank to another due to, for example, slight variations in the respective vertical position or the respective ink sensing windows 52-1, 52-2, 52-3, and 52-4 relative to optical ink sensor device 54. Also, among a group of similarly configured machines, e.g., multiple imaging apparatuses 14, there may be further variations in the sensor outputs of optical ink sensor device 54 due to, for example, light emitter and/or light detector variations, differences in distance 56 from one machine to another, machine assembly inaccuracies, and printhead carrier wear differences. The present invention provides a method and apparatus for compensating for the effects of these variables through a calibration of an ink sense response of the optical ink sensor device 54.

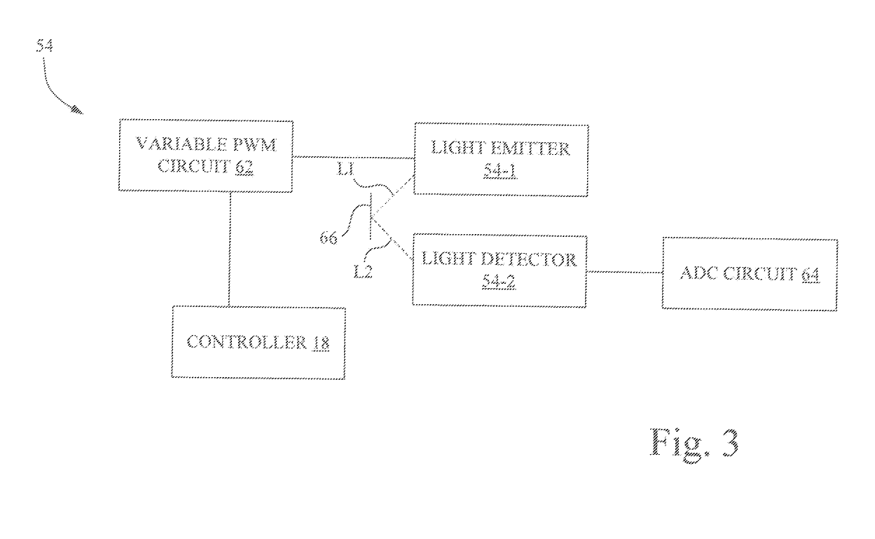

FIG. 3 is a block diagram of an exemplary circuit in accordance with one embodiment of optical ink sensor device 54 for use in generating an ink sense response to a reading of the ink tank status at a respective ink sensing window 52-1, 52-2, 52-3, and 52-4 of ink tanks 50-1, 50-2, 50-3 and 50-4. In the embodiment of FIG. 3, optical ink sensor device 54 further includes a variable pulse width modulation (PWM) circuit 62 connected to light emitter 54-1, and an analog-to-digital (ADC) circuit 64 connected to light detector 54-2. Controller 18 is connected to PWM circuit 62 and ADC circuit 64.

An ink sensing operation may be performed, for example, as follows. Based on the control signals supplied by controller 18, PWM circuit 62 generates a PWM signal which is supplied to light emitter 54-1. In turn, light L1 is generated by light emitter 54-1 based on the PWM signal supplied by PWM circuit 62. Light L2 reflected by a reflective surface 66, such as one of ink sensing windows 52-1, 52-2, 52-3, and 52-4 or a reference reflective surface 70 (see FIG. 2), is received by light detector 54-2. Light detector 54-2 generates an analog detection signal, which is processed by ADC circuit 64. ADC circuit 64 then generates a digital detection signal corresponding to the analog detection signal. The digital detection signal is then received by controller 18 for further processing, or saving in a memory, such as a memory 65 (see FIG. 2) associated with an ink tank 50. In some embodiments, a respective memory 65 may be attached to each ink tank 50 and/or printhead 48.

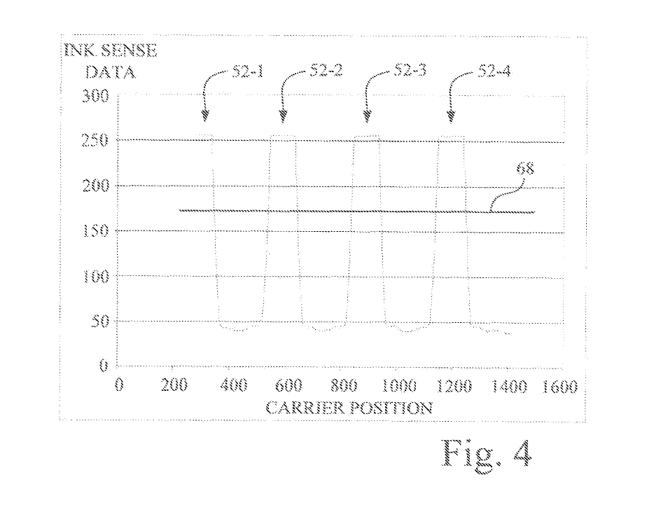

When ink sensing is performed, printhead carrier 34 is moved to the carrier position associated with the center of each ink sensing window 52-1, 52-2, 52-3, and 52-4 of ink tanks 50-1, 50-2, 50-3 and 50-4, as illustrated in the plot of FIG. 4. In the present embodiment, the ink sense data represented by the digital detection signal output of ADC circuit 64 increases in ADC value as the amount of ink in a respective ink tank 50 decreases. A decision of an out of ink condition with respect to one or more of ink tanks 50-1, 50-2, 50-3 and 50-4 is made by controller 18 based on this ADC value being larger than some predetermined ink-out threshold value 68. As illustrated in FIG. 4, the ink sense data is correlated with the carrier position data generated by carrier position encoder 40 to create a light reflectivity map of the bottom of ink tanks 50-1, 50-2, 50-3 and 50-4 and printhead carrier 34.

However, as discussed above, the ink sense data may be adversely affected by ink tank status sensing variables of imaging apparatus 14, e.g., variations in the sensor outputs of optical ink sensor device 54, variations in distance 56 between the plane of optical ink sensor device 54 and an ink sensing window 52-1, 52-2, 52-3, and 52-4, machine assembly inaccuracies, printhead carrier wear differences, etc. For example, an increase in distance 56, e.g., one millimeter, between the plane 58 extending between light emitter 54-1 and light detector 54-2 and the ink sensing windows 52-1, 52-2, 52-3, and 52-4 of ink tanks 50-1, 50-2, 50-3 and 50-4 may prevent an ink tank 50 having an “Ink Tank Empty” status from reflecting enough light to increase the ADC value to the ink-out threshold value 68.

In order to compensate for any individual or combination of the ink rank sensing variables, the present invention includes a reference reflective surface 70 (see FIG. 2) carried by printhead carrier 34, e.g., formed on a bottom surface 34-1 of printhead carrier 34, or alternatively on the bottom of one of ink tanks 50-1, 50-2, 50-3 and 50-4 carried by printhead carrier 34, that is used in calibrating the ink sense response of optical ink sensor device 54 to take into account the ink tank status sensing variables of imaging apparatus 14 discussed above. Reference reflective surface 70 has a known surface reflectance, e.g., optical density. Reference reflective surface 70 may be termed directly in the plastic structure of printhead carrier 34, or alternatively an ink tank, or may be applied to bottom surface 34-1 of printhead carrier 34, or to a bottom surface of one of ink tanks 50-1, 50-2, 50-3 and 50-4 carried by printhead carrier 34, such as for example, as a reflective tape, paint etc.

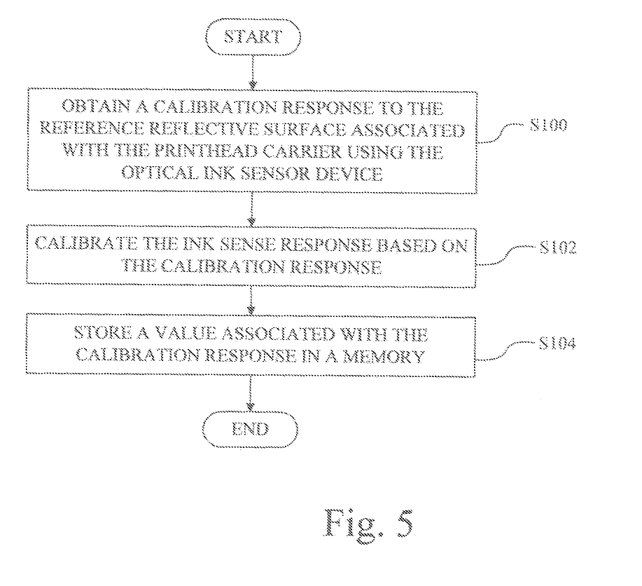

FIG. 5 is a flowchart of a method for calibrating an Ink sense response of optical ink sensor device 54 in imaging apparatus 14, which is configured to facilitate optical ink sensing for an ink tank, such as one or more of ink tanks 50-1, 50-2, 50-3 and 50-4 having an ink sensing window 52-1, 52-2, 52-3, and 52-4. The method is performed to compensate for any individual or combination of the ink tanks status sensing variables, as described by example above. The method may be implemented, for example, as program instructions executed by controller 18.

At act S100, a calibration response to reference reflective surface 70 associated with printhead carrier 34 is obtained using optical ink sensor device 54. The calibration response may be in the form of an ADC value associated with reference reflective surface 70 of printhead carrier 34 as determined by optical ink sensor device 54.

At act S102, the ink sense response is calibrated based on the calibration response.

At act S104, a value, such as a measured response value, associated with the calibration response is stored in a memory, such as memory 65 of one of the respective ink tank 50-1, 50-2, 50-3 and 50-4 or printhead 48.

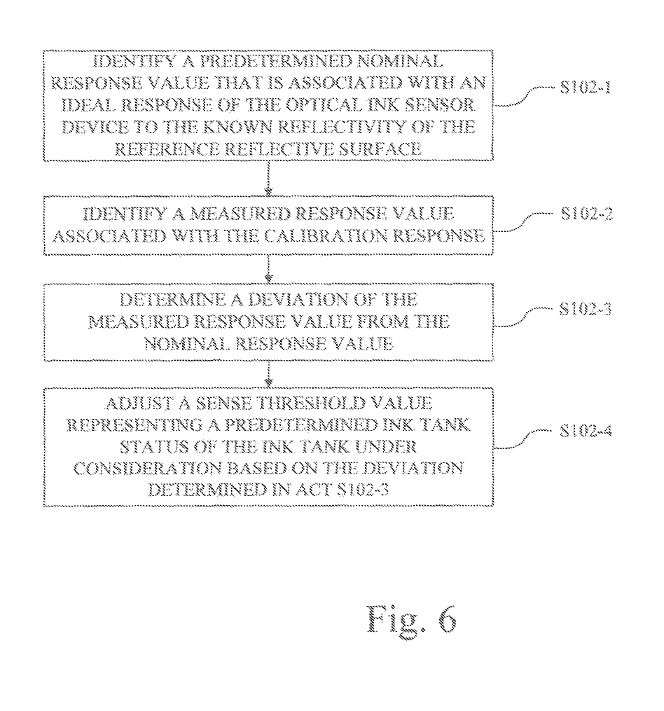

FIG. 6 is a flowchart of method acts according to one exemplary embodiment for performing act S102.

At act S102-1, a predetermined nominal response value is identified that is associated with an ideal response of optical ink sensor device 54 to the known reflectivity of reference reflective surface 70 of printhead carrier 34. The predetermined nominal response value may be, for example, a nominal value determined empirically during system design.

At act S102-2, a measured response value associated with the calibration response is identified. The measured response value may be the ADC value provided by ADC circuit 64, which is associated with reference reflective surface 70 associated with printhead carrier 34 as determined by optical ink sensor device 54 in act S100.

At act S102-3, a deviation of the measured response value from the nominal response value is determined.

The deviation may be, for example, a ratio of the measured response value and the nominal response value. In one embodiment, for example, ADC circuit 64 of optical ink sensor device 54 provides a digital detection signal value as the measured response value, and the nominal response value is a nominal digital response value.

At act S102-4, a sense threshold value representing a predetermined ink tank status of the ink tank 50 under consideration is adjusted based on the deviation determined in act S102-3. For example, the adjusting may adjust the threshold value associated with a particular ink tank status of a particular ink tank, e.g., one of ink tanks 50-1, 50-2, 50-3 and 50-4, based on the ratio of the measured response value and the nominal response value.

Sense threshold value 68 may be, for example, one of a plurality of sense threshold values, wherein the act of adjusting is performed for each threshold, value of the plurality of sense threshold values. Each of the plurality of sense threshold values delineate a plurality of ink tank statuses for a particular ink tank, such as for example ink tank 50-1. Table 1, below, shows ranges of ADC values corresponding to each of three exemplary ink tank statuses, namely. Ink Tank Missing, Ink Tank Present, and Ink Tank Empty (i.e., ink-out threshold value 68).

TABLE I
Ink Tank Status

| ADC Value | Ink Tank Status |
|---|---|
| 0-48 | Ink Tank Missing |
| 49-175 | Ink Tank Present |
| 176-255 | Ink Tank Empty |

In Table I, for example, a threshold value of 176 sets the lower boundary for indicating an “Ink Tank Empty” ink tank status, and a second threshold value of 49 sets the lower boundary for indicating an “Ink Tank Present” ink tank status. As an example, if the distance 56 from ink sensing window 52-1 to the plane 58 extending between light emitter 54-1 and light detector 54-2 is larger than nominal for ink tank 50-1, then the ADC value for the threshold for the ink tank status “Ink Tank Empty” for ink tank 50-1 may be changed from 176 shown in Table 1, to a larger value, e.g., 190, in order to accurately reflect the ink tank status “Ink Tank Empty” for ink tank 50-1, and thereby protect printhead 42 from ink starvation.

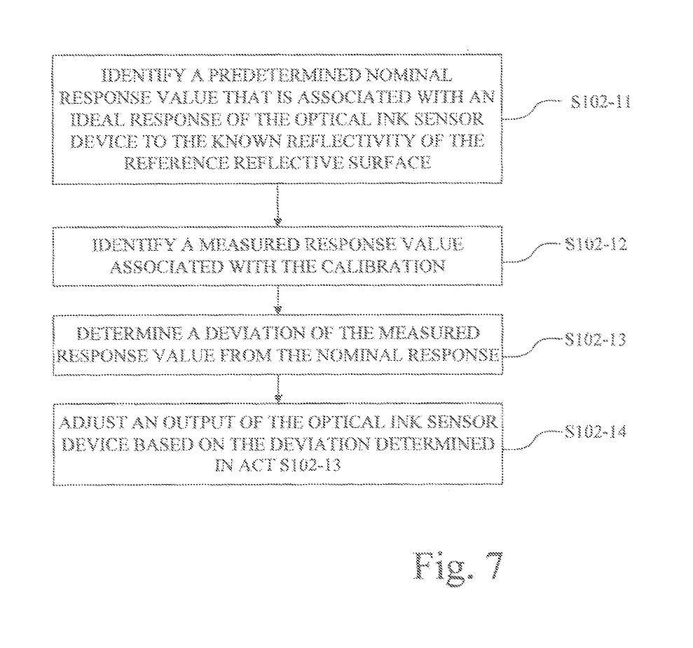

FIG. 7 is a flowchart of method acts according to another exemplary embodiment for performing act S102.

At act S102-11, a predetermined nominal response value is identified that is associated with an ideal response of optical ink sensor device 54 to the known reflectivity of reference reflective surface 70 of printhead carrier 34. The predetermined nominal response value may be, for example, a nominal value determined empirically during system design.

At act S102-12, a measured response value associated with the calibration response is identified. The measured response value may be the ADC value provided by ADC circuit 64, which is associated with reference reflective surface 70 associated with printhead carrier 34 as determined by optical ink sensor device 54 in act S100.

At act S102-13, a deviation of the measured response value from the nominal response is determined. The deviation may be, for example, a ratio of the measured response value and the nominal response value. In one embodiment, for example, ADC circuit 64 of optical ink sensor device 54 provides a digital detection signal value as the measured response value, and the nominal response value is a nominal digital response value.

At S102-14, an output of optical ink sensor device 54 is adjusted that is associated with the ink sense response based on the deviation determined at act 102-13. For example, the adjusting may adjust the output (e.g., the digital detection signal output of ADC circuit 84) based on the ratio of the measured response value and the nominal response value.

As a more specific example, based on the ratio the act of adjusting may adjust a pulse width of the pulse width modulation signal generated by PWM circuit 62 to adjust the output of optical ink sensor device 54. In this example, an increase of the pulse width of the pulse width modulation signal results in an increase in the digital detection signal value.

Since different inks reflect the light L1 emitted by light emitter 54-1 differently, ink tank specific PWM levels may be used for each ink tank 50-1, 50-2, 50-5 and 50-4 to equalize all ink tank colors and equalize the “Ink Tank Empty” and/or other threshold levels. For example, if the monochrome tank 50-1 or its monochrome ink is less reflective than the color ink tanks 50-2, 50-3 and 50-4 or their respective color inks, then the PWM signal fed to light emitter 54-1 may be increased to bring the “Ink Tank Empty” status for ink tank 50-1 up to the same level as is returned from the other color ink tanks 50-2, 50-3, and 50-4. Alternatively, the PWM levels for color ink tanks 50-2, 50-3, and 50-4 could be decreased to bring them down to the same level as monochrome ink tank 50-1.

Alternatively, printhead carrier 34 may be moved to a known position so that a reference reflective surface 70 is aligned above optical ink sensor device 54. PWM signal output by PWM circuit 62 is then varied until a pre-determined ADC value is reached. From this information the system response may be determined from the PWM value necessary to reach a pre-set ADC value.

Those skilled in the art will recognise that use methods described above with respect to FIGS. 6 and 7 may be used individually or in combination.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for calibrating an ink sense response of an optical ink sensor device in an imaging apparatus configured to facilitate optical ink sensing lot an ink tank having an ink sensing window, comprising:
obtaining a calibration response to a reference reflective surface having a known reactivity, which is associated with a printhead carrier of said imaging apparatus that carries said ink tank, using said optical ink sensor device; and
calibrating said ink sense response based on said calibration response.

2. The method of claim 1, wherein the act of calibrating includes:
identifying a predetermined nominal response value associated with an ideal response of said optical ink sensor device to said known reflectivity;
identifying a measured response value associated with said calibration response;
determining a deviation of said measured response value from said nominal response value; and
adjusting a sense threshold value representing a predetermined ink tank status of said ink tank based on said deviation.

3. The method of claim 2, wherein said deviation is a ratio of said measured response value and said nominal response value, and said adjusting adjusts said sense threshold value associated with a particular ink tank status of said ink tank based on said ratio.

4. The method of claim 3, wherein said optical ink sensor device includes an analog-to-digital circuit providing a digital detection signal value as said measured response value, and said nominal response value is a nominal digital response value.

5. The method of claim 2, wherein said sense threshold value is one of a plurality of sense threshold values, wherein the acts of adjusting is performed for each threshold value of said plurality of sense threshold values.

6. The method of claim 5, wherein each of said plurality of sense threshold values delineate a plurality of ink tank statuses for said ink tank.

7. The method of claim 6, wherein a first ink tank threshold value delineates a first ink tank status from a second ink tank status, and a second ink tank threshold value delineates said second ink tank status from a third ink tank status.

8. The method of claim 7, wherein said first ink tank status is ink tank missing status, said second ink tank status is an ink tank present status, and said third ink tank status is an ink tank empty status.

9. The method of claim 2, wherein said predetermined ink tank status represents an ink tank empty status of said ink tank.

10. The method of claim 1, wherein the act of calibrating includes:
identifying a predetermined nominal response value associated with, an ideal response of said optical ink sensor device to said known reflectivity;
identifying a measured response value associated with said calibration response;
determining a deviation of said measured response value from said nominal response value; and
adjusting an output of said optical ink sensor device associated with said ink sense response based on said deviation.

11. The method of claim 10, wherein said deviation is a ratio of said measured response value and said nominal response value, and wherein the act of adjusting adjusts said output by said ratio.

12. The method of claim 11, wherein said optical ink sensor device includes an analog-to-digital circuit providing a digital detection signal value as said measured response value, and said nominal response value is a nominal digital response value.

13. The method of claim 12, wherein said optical ink sensor device includes a pulse width modulation circuit, and wherein based on said ratio the act of adjusting adjusts a pulse width of a pulse width modulation signal generated by said pulse width modulation circuit to adjust said output of said optical ink sensor device.

14. The method of claim 13, wherein an increase of said pulse width of said pulse width modulation signal results in an increase in said digital detection signal value.

15. The method of claim 1, bather comprising storing a value associated with said calibration response in a memory of at least one of said ink tank and a printhead.

16. An imaging apparatus, comprising:
a printhead carrier;
a printhead coupled to said printhead carrier;
an ink tank coupled to said printhead carrier, said ink tank having an ink sensing window;
a memory associated with said ink tank;
optical ink sensor device positioned to receive light reflected from said ink sensing window for sensing an ink tank status to facilitate optical ink sensing for said ink tank;
a reference reflective surface carried by said printhead carrier, said reference reflective surface having a known reflectivity; and
a controller communicatively coupled to said printhead, said memory, and said optical ink sensor device, said controller executing program instructions for calibrating an ink sense response of said optical ink sensor device in said imaging apparatus, comprising:
obtaining a calibration response of said optical ink sensor device to said reference reflective surface; and
calibrating said ink sense response based on said calibration response.

17. The imaging apparatus of claim 16, wherein said calibrating includes:
identifying a predetermined nominal response value associated with an ideal response of said optical ink sensor device to said known reflectivity;
identifying a measured response value associated with said calibration response;
determining a deviation of said measured response value from said nominal response value; and
adjusting a sense threshold value representing a predetermined ink tank slants of said ink tank based on said deviation.

18. The imaging apparatus of claim 17, wherein said deviation is a ratio of said measured response value and said nominal response value, and said adjusting adjusts said threshold value associated with a particular ink tank status of said ink tank based on said ratio.

19. The imaging apparatus of claim 16, wherein said calibrating includes:
identifying a predetermined nominal response value associated with an ideal response of said optical ink sensor device to said known reflectivity;
identifying a measured response value associated with said calibration response;
determining a deviation of said measured response value from said nominal response value; and
adjusting an output of said optical ink sensor device associated with said ink sense response based on said deviation.

20. The imaging apparatus of claim 19, wherein said optical ink sensor device includes an analog-to-digital circuit providing a digital detection signal value as said output, and a pulse width modulation circuit and wherein based on said deviation the act of adjusting adjusts a pulse width of a pulse width modulation signal generated by said pulse width modulation circuit to adjust said output of said optical ink sensor device.
